(19) United States
(12) Patent Application Publication
(10) Pub. No.: US 2018/0209554 A1
(43) Pub. Date: Jul. 26, 2018

(54) INJECTION VALVE, EXHAUST-GAS AFTERTREATMENT SYSTEM

(71) Applicant: Robert Bosch GmbH, Stuttgart (DE)

(72) Inventor: Rainer Haeberer, Bretten (DE)

(21) Appl. No.: 15/746,642

(22) PCT Filed: May 31, 2016
(86) PCT No.: PCT/EP2016/062213

§ 371 Date: Jan. 22, 2018

(30) Foreign Application Priority Data
Jul. 22, 2015 (DE) 10 2015 213 814.3

(51) Int. Cl. F16K 15/02; F01N 3/20; F16K 1/54

(52) U.S. Cl. CPC F16K 15/025; F01N 3/208; F16K 1/54; F01N 2610/1453; F01N 2610/1406; F01N 2610/1433; F01N 2610/02

(57) ABSTRACT

The invention relates to an injection valve (4), in particular of an exhaust-gas aftertreatment system (1), having an axially displaceable valve element (12), having a valve opening (10) which is assigned to a valve seat (11) of the valve element (12), having a piston (21) which is fixedly connected to the valve element (12) and which is led through the valve opening (10), and having a spring element (20) which forces the piston (21) with the valve element (12) against the valve seat (11), wherein the valve element (12) is displaceable in a spray chamber (14) which, opposite the valve element (12), has multiple spray openings (16, 18). It is provided that at least two first spray openings (16) have central axes (17) which intersect outside the injection valve, and/or that a centrally situated second spray opening (18) has a larger diameter than the other spray openings (16).

### BACKGROUND OF THE INVENTION

The invention relates to an injection valve, in particular for an exhaust gas aftertreatment system of a motor vehicle, having an axially movable valve element, having a valve opening which is assigned a valve seat for the valve element, having a piston which is connected fixedly to the valve element and is guided through the valve opening, and having a spring element which pushes the piston with the valve element against the valve seat, it being possible for the valve element to be moved in an injection chamber which has a plurality of injection openings in a manner which lies opposite the valve element.

Furthermore, the invention relates to an exhaust gas aftertreatment system having an injection valve of this type.

In motor vehicles having an internal combustion engine, the pollutant NOx has to be reduced, inter alia, on account of the increasingly stringent exhaust gas legislation, in order for it to be possible for the statutory requirements to be observed. A known method for reducing the NOx pollutants is what is known as the SCR method (SCR=selective catalytic reduction), in which the pollutant NOx is reduced to form nitrogen and hydrogen with the aid of a liquid reducing agent, in particular an aqueous urea solution. The reducing agent is usually conveyed by means of a conveying pump from a tank to an injection valve which is configured, for example, as a pump-nozzle unit. It is compressed there and fed to the exhaust gas as a fine spray via the injection valve. The configuration of the injection valve as a pump-nozzle unit produces the advantage that the compression of the reducing agent is performed only directly at the exhaust gas pipe. As a result, a very high pressure can be generated which, in conjunction with a suitable injection geometry, leads to a very fine spray. The finer the spray, the better the reducing agent can react together with the exhaust gas in an SCR catalytic converter.

Injection valves of the type mentioned at the outset are known, for example, from laid open specification EP 1 878 920 A1. Here, the injection valve is configured as an outwardly opening valve, in which a piston which actuates the valve element is guided through the valve opening and is prestressed by way of the spring element on that side of the valve opening which lies opposite the valve element, in order to pull the valve element into the valve seat. It is a disadvantage in the case of the known solution that only a hollow spray can be generated as a consequence of the outwardly opening valve element, and that faultless functionality of the injection valve can no longer be ensured if low temperatures occur which lead to freezing of the reducing agent.

### SUMMARY OF THE INVENTION

The injection valve according to the invention has the advantage that the ice pressure resistance of the injection valve is increased in comparison with known solutions, and that a hollow spray can be avoided and therefore the distribution of the reducing agent in the exhaust gas can be improved by way of a simple measure. To this end, the injection valve according to the invention is distinguished by the fact that at least two first ones of the injection openings have center axes which cross outside the injection valve, and/or that a second injection opening which lies centrally has a diameter which is greater in comparison with the remaining injection openings. The two first injection openings therefore have center axes which cross outside the injection valve. The center axes define an orientation of the respective injection opening. In particular, the injection openings are to be understood to be bores, in particular in an injection hole plate, which have a center axis in accordance with the bore axis. At least two of the first injection hole openings are therefore configured and oriented in such a way that their sprays meet outside the injection hole plate or the injection valve. As a result, what is known as a collision jet is generated, by way of which the reducing agent is atomized further on account of the sprays which come into contact with one another, and is distributed in the exhaust gas of the internal combustion engine in an improved manner as a result. In addition or as an alternative, the second injection opening which lies centrally, in particular, in the injection hole plate is configured, which second injection opening has a diameter which is greater in comparison with the remaining injection openings. The comparatively large injection opening achieves a situation where reducing agent which is situated in the injection chamber evaporates or escapes through the injection opening as a consequence of trapped heat in the case of a closed valve. This achieves a situation where, if the system is switched off at ambient temperatures below the freezing point of the reducing agent, no reducing agent remains in the injection chamber, which reducing agent might lead to a leak of the injection valve or, in particular, to damage of the injection hole plate on account of freezing reducing agent. This embodiment according to the invention therefore achieves a situation where the injection valve is configured so as to be resistant to the ice pressure.

It is expediently provided that the injection chamber has an internal diameter which is greater than the maximum external diameter of the valve element. As a result, a flow path for the reducing agent during operation and a space in the injection chamber are provided, in which space reducing agent which possibly nevertheless remains can freeze after the system is switched off, without damaging the injection valve.

Furthermore, it is preferably provided that the first injection openings lie at least substantially radially outside the valve element. As a result, an advantageous media flow from the valve opening to the injection openings is achieved during the movement of the valve element away from the valve seat in order to open the valve opening.

It is provided according to one preferred development of the invention that the valve element is of frustoconical configuration and has a flat rear side which lies opposite the injection holes of the injection hole plate. The rear side preferably serves as an axial stop for the valve element which can be guided as far as up to the injection hole plate as a result. The above-described dimensioning of the injection chamber ensures that the reducing agent can escape through the injection openings which lie radially outside the valve element even in the case of a completely open valve, that is to say when the rear side of the valve element bears against the injection hole plate. If the central second injection opening is configured in the injection hole plate, it is preferably closed here by way of the valve element, with the result that the reducing agent does not escape through the comparatively great injection opening, but rather is guided in a targeted manner through the first injection openings.

The valve element preferably has an axial projection on its rear side. The maximum movement of the valve element in the injection chamber can be defined by way of said axial projection. To this extent, the axial projection serves substantially as an axial stop for the valve element. The axial projection can achieve a situation, in particular, where injection openings which lie radially within the valve element and would otherwise be closed by the rear side of the valve element can also be loaded with reducing agent in the case of a valve element which is opened to a maximum extent. In this respect, the axial projection is preferably arranged in a region, in which none of the first injection openings is situated.

Furthermore, it is preferably provided that the axial projection is arranged centrally and is of wider configuration than the second injection hole opening, in order to close the second injection opening in the case of a maximum movement of the valve element. The axial projection therefore seals the central second injection opening completely when the valve element has been moved to a correspondingly far extent into its maximum opening position. As a result, in particular, an advantageous combination of a wide second injection opening and first injection openings which can then also be situated in the region of the valve element is achieved. As a result, in particular, the advantage is achieved that reducing agent is guided reliably through the first injection openings, and the second injection opening is closed reliably.

It is particularly preferably provided that the second injection opening has a diameter of at least 0.5 mm. This ensures that the reducing agent can flow independently out of the injection chamber, without the second injection opening being closed, for example, by crystals which are produced during freezing of the reducing agent.

The exhaust gas aftertreatment system according to the invention is distinguished by the injection valve according to the invention. This results in the advantages which have already been mentioned. Further features and advantages result from what has been described above and from the claims.

### BRIEF DESCRIPTION OF THE DRAWINGS

In the following text, the invention is to be described in greater detail using the drawing, in which:

FIG. 1 shows an exhaust gas aftertreatment system of a motor vehicle in a simplified illustration, and

FIG. 2 shows an injection valve of the exhaust gas aftertreatment system in an enlarged sectional illustration.

### DETAILED DESCRIPTION

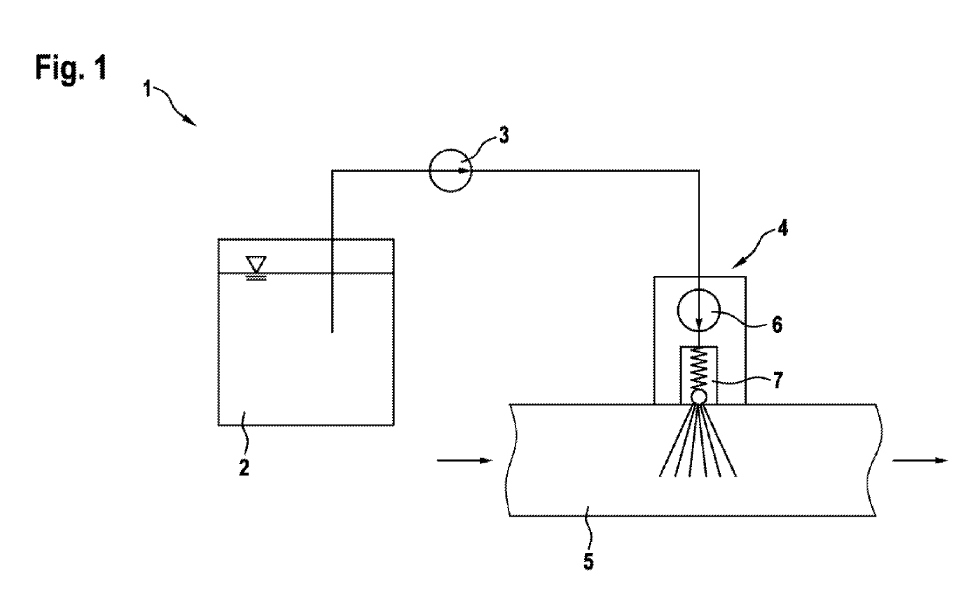

FIG. 1 shows a simplified illustration of an exhaust gas aftertreatment system 1 for a motor vehicle (not shown in greater detail here). The exhaust gas aftertreatment system 1 has a tank 2 which serves to store and provide a liquid reducing agent or exhaust gas aftertreatment agent, in particular an aqueous urea solution. The liquid reducing agent can be removed from the tank 2 and can be conveyed to an injection valve 4 by means of a conveying pump 3. The injection valve 4 is assigned to an exhaust gas pipe 5 of an internal combustion engine (not shown in greater detail here) of the motor vehicle, in order to inject the reducing agent into the exhaust gas of the internal combustion engine. Here, the injection valve 4 is configured as a pump-nozzle unit which comprises an integrated conveying device 6, in particular a pump, and a pressure-controlled valve 7 (shown here merely in simplified form).

On account of a possibly long intake line and the high temperatures which prevail in the exhaust gas pipe, it is advantageous that the conveying pump 3 is provided in addition to the pump and is arranged, in particular, on the tank 2, in order to already pressurize the liquid to a pressure of from 2 to 3 bar upstream of the pump-nozzle unit, and to feed it in this way to the pump-nozzle unit. The further pump of the injection valve 4 achieves the advantage that the subsequent compression of the reducing agent is achieved/performed only directly upstream of the injection point. As a result, a very high injection pressure can be generated which leads to an advantageously fine spray. As an alternative, one of the two pumps can also be dispensed with.

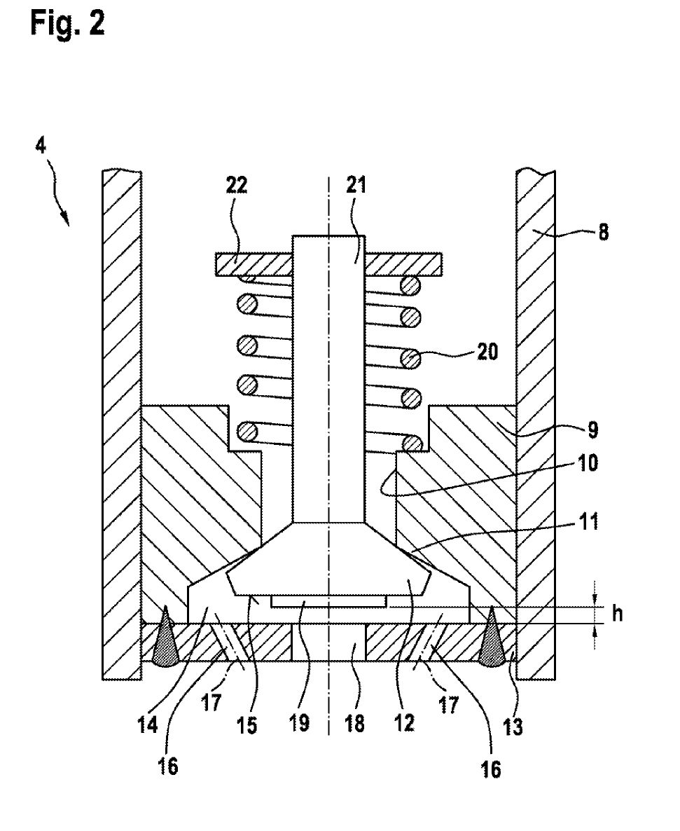

FIG. 2 shows a simplified sectional illustration of an enlarged detail of the injection valve 4 of the exhaust gas aftertreatment system 1 from FIG. 1. Elements which are already known are provided with the same designations, with the result that reference is made in this respect to the above description.

The injection valve 4 has a housing 8 which is of sleeve-shaped configuration. A valve support 9 is inserted into the housing, which valve support 9 has an axial valve opening 10 which is assigned a valve seat 11. Here, the valve seat 11 is configured so as to taper toward the valve opening 10 in a funnel-shaped manner. Here, the valve seat 11 is arranged on the injection side of the injection valve 4.

Furthermore, the injection valve 4 has a valve element 12 which is of frustoconical configuration in the manner of a valve head, and has an external diameter which is greater than the internal diameter of the valve opening 10, in order to close the valve opening 10 sealingly when bearing against the valve seat 11. Together with an injection hole plate 13, the support element 9 forms an injection chamber 14, in which the valve element 12 can be moved. To this extent, the injection chamber 14 is delimited by way of the injection hole plate 13, the support element 11 and the closed valve element 12. The injection hole plate 13 extends perpendicularly with respect to the direction of movement of the valve element 12, and is, in particular, welded to the support element 9. In order that the valve element 12 can be moved axially, the injection hole plate 13 is arranged spaced apart from the rear side 15 of the valve element 12. Moreover, the injection chamber 14 has an internal diameter which is greater than the maximum external diameter of the valve element 12, with the result that clearances result in the injection chamber 14 in every case, that is to say independently of the position of the valve element 12.

The injection hole plate 13 has a plurality of first injection hole openings 16 which are arranged spaced apart uniformly from one another on a diameter of the injection hole plate 13, the injection hole openings 16 lying substantially radially outside the valve element 12 or on a diameter which is greater than the maximum external diameter of the valve element 12. The first injection hole openings 16 in each case have a center axis 17 which is oriented in an inclined manner. Here, the center axes 17 are oriented in an inclined manner such that they cross outside the injection valve 4, as indicated in FIG. 2 by way of dashed lines. Furthermore, the injection hole plate 13 has a central or middle second injection opening 18 which has a diameter which is greater in comparison with the injection openings 16. In particular, the injection opening 18 has a diameter of at least 0.5 mm.

Moreover, on its rear side 15, the valve element 12 has an axial projection 19 which is likewise arranged centrally and has an external diameter which is greater than that of the injection opening 18. Here, the spacing h of the axial projection 19 from the injection hole plate 13 in the closed state of the valve defines the adjustment travel or the lift of the valve element 12.

In the normal state, the valve element 12 is pulled into the valve seat 11 by way of a spring element 20, with the result that the valve opening 10 closes. To this end, a piston 21 is connected fixedly to the valve element 12 and is guided through the valve opening 10. On the rear side of the support element 9, which rear side faces away from the valve element 12, the spring element 20 is held in a prestressed manner between the support element 9 and a stop 22 which is connected fixedly to the piston 21. In the present case, the spring element 20 is configured as a helical spring which is arranged coaxially with respect to the piston 21.

If, in operation, the pressure is then increased to a sufficiently great extent by way of the conveying device 3 and/or the pump 6, the valve element 12 is released from the valve seat 11 counter to the force of the spring element 20, with the result that the valve opening 10 is opened at least in regions. The reducing agent then flows past the valve element 12 into the injection chamber 14 and from there to the injection openings 16 and into the exhaust gas pipe 5. Here, on account of the advantageous inclination of the center axes 17, the sprays from the injection openings 16 meet one another, which leads to further atomization of the reducing agent and in the process to improved mixing of the reducing agent with the exhaust gas. What are known as collision sprays/jets are produced.

The valve element 12 is moved with the axial projection 19 as far as onto the injection hole plate 13. Here, the axial projection 19 seals or closes the injection opening 18 in this position, with the result that no reducing agent can escape through the opening 18 in an undesired manner.

Outwardly opening valve elements with an injection hole plate normally have the problem that the injection hole plate can be deformed and therefore the armature lift or the lift of the valve element can change the injection hole geometry in the case of freezing of the aqueous urea solution or the reducing agent as a consequence of the expansion of volume during the phase shift. As a result, the injection quantity and the shape of the output spray can change. In the case of freezing, the reducing agent expands and can lead to the valve element being pushed away from the valve seat. As a consequence, the injection valve leaks.

The advantageous configuration of the injection valve 4 achieves a situation where the comparatively great injection opening 18 is free in the closed state, that is to say when the valve element 12 bears against the valve seat 11, with the result that reducing agent which is situated in the injection chamber 14 evaporates as a consequence of trapped heat or flows out via the injection opening 18. The smaller injection openings 16 can close rapidly on account of dirt/soot and the formation of crystals, the greater injection opening 18 continuing to make an outflow of reducing agent possible. It is therefore prevented that reducing agent can collect and freeze in the injection chamber 14 when the injection valve 4 leaks, which might lead to damage of the injection hole plate 13.

Moreover, the injection opening 18 has the advantage that no vacuum is produced in the injection chamber 14 during the closing operation of the valve element 12, with the result that the injection valve 4 can close in a very rapid and sealed manner. Moreover, the lift of the valve element 12 can be measured or checked in a simple way via the great injection opening 18.

1. An injection valve (4) comprising
an axially movable valve element (12),
a valve opening (10) with a valve seat (11) for the valve element (12),
a piston (21) which is connected fixedly to the valve element (12) and is guided through the valve opening (10),
a spring element (20) which pushes the piston (21) with the valve element (12) against the valve seat (11),
an injection chamber (14) in which the valve element (12) moves, the injection chamber having a plurality of injection openings (16, 18) opposite the valve element (12), the plurality of injection openings including at least two first injection openings and a second injection opening,
wherein the first injection openings (16) have center axes (17) which cross outside the injection valve.

2. The injection valve as claimed in claim 1, characterized in that the injection chamber (14) has an internal diameter which is greater than an external diameter of the valve element (12).

3. The injection valve as claimed in claim 1, characterized in that one of the first injection openings (16) lies at least substantially radially outside the valve element (12).

4. The injection valve as claimed in claim 1, characterized in that the injection openings (16, 18) are configured in an injection hole plate (13).

5. The injection valve as claimed in claim 4, characterized in that the valve element (12) is of frustoconical configuration and has a flat rear side (15) which lies opposite the injection hole plate (13).

6. The injection valve as claimed in claim 1, characterized in that the valve element (12) has an axial projection (19) on a rear side (15).

7. The injection valve as claimed in claim 6, characterized in that the axial projection (19) is arranged centrally and is of wider configuration than the second injection opening (18), in order to close the second injection opening (18) in the case of a maximum movement of the valve element (12).

8. The injection valve as claimed in claim 7, characterized in that the second injection opening (18) has a diameter of at least 0.5 mm.

9. The injection valve as claimed claim 1, characterized in that the injection valve is configured as a pump-nozzle unit (6, 7).

10. An exhaust gas aftertreatment system (1) for an internal combustion engine, having a tank (2) for providing a liquid exhaust gas aftertreatment agent, having an injection valve (4) for metered injection of the exhaust gas aftertreatment agent into the exhaust gas of an internal combustion engine, wherein the injection valve (4) is configured as claimed in claim 1.

11. The exhaust gas aftertreatment system as claimed in claim 10, characterized in that a conveying device (3) is provided for conveying the liquid exhaust gas aftertreatment agent from the tank (2) to the injection valve.

12. An injection valve (4) comprising
an axially movable valve element (12),
a valve opening (10) with a valve seat (11) for the valve element (12),
a piston (21) which is connected fixedly to the valve element (12) and is guided through the valve opening (10),
a spring element (20) which pushes the piston (21) with the valve element (12) against the valve seat (11), and
an injection chamber (14) in which the valve element (12) moves, the injection chamber having a plurality of injection openings (16, 18) opposite the valve element (12), the plurality of injection openings including at least two first injection openings and a second injection opening,
wherein the second injection opening (18) lies centrally and has a diameter which is greater in comparison with the remaining injection openings (16).

13. The injection valve as claimed in claim 12, characterized in that the injection chamber (14) has an internal diameter which is greater than an external diameter of the valve element (12).

14. The injection valve as claimed in claim 12, characterized in that one of the first injection openings (16) lies at least substantially radially outside the valve element (12).

15. The injection valve as claimed in claim 12, characterized in that the injection openings (16, 18) are configured in an injection hole plate (13).

16. The injection valve as claimed in claim 15, characterized in that the valve element (12) is of frustoconical configuration and has a flat rear side (15) which lies opposite the injection hole plate (13).

17. The injection valve as claimed in claim 12, characterized in that the valve element (12) has an axial projection (19) on a rear side (15).

18. The injection valve as claimed in claim 17, characterized in that the axial projection (19) is arranged centrally and is of wider configuration than the second injection opening (18), in order to close the second injection opening (18) in the case of a maximum movement of the valve element (12).

19. The injection valve as claimed in claim 18, characterized in that the second injection opening (18) has a diameter of at least 0.5 mm.

20. The injection valve as claimed in claim 12, characterized in that the injection valve is configured as a pump-nozzle unit (6, 7).

21. An injection valve (4) comprising
an axially movable valve element (12),
a valve opening (10) with a valve seat (11) for the valve element (12),
a piston (21) which is connected fixedly to the valve element (12) and is guided through the valve opening (10),
a spring element (20) which pushes the piston (21) with the valve element (12) against the valve seat (11), and
an injection chamber (14) in which the valve element (12) moves, the injection chamber having a plurality of injection openings (16, 18) opposite the valve element (12), the plurality of injection openings including at least two first injection openings and a second injection opening,
wherein the first injection openings (16) have center axes (17) which cross outside the injection valve, and the second injection opening (18) lies centrally and has a diameter which is greater in comparison with the remaining injection openings (16).
